(19) United States
(12) Patent Application Publication
(10) Pub. No.: US 2021/0038950 A1
(43) Pub. Date: Feb. 11, 2021

(54) System and Apparatus to collect tennis balls in the court

(71) Applicant: Brennan T Sullivan, Roswell, GA (US)

(72) Inventor: Brennan T Sullivan, Roswell, GA (US)

(21) Appl. No.: 16/945,817

(22) Filed: Aug. 1, 2020

Related U.S. Application Data
(60) Provisional application No. 62/884,170, filed on Aug. 8, 2019.

(51) Int. Cl. A63B 47/02; B65G 33/04; G05D 1/00; G01S 15/931; G05D 1/02

(52) U.S. Cl. CPC A63B 47/021; B65G 33/04; G05D 1/0088; A63B 2102/02; G05D 1/0253; G05D 1/0212; A63B 2047/022; G01S 15/931

(57) ABSTRACT

The present invention relates to a tennis ball picking robot that picks up scattered tennis balls in the court. The invention is a compact robot with greater ball collection capacity and smaller footprint. The invention comprises a computing system, a custom trained neural network executing on the computing system, vision and proximity sensors, the mechanical apparatus to collect tennis balls in the ball collection basket and an electric energy source. The custom trained neural network is trained using a data set to collect balls effectively using a camera and distance sensors.

### FIELD OF INVENTION

The application claims priority from a Provisional U.S. Patent App No. 62/884,170 filed on 8 Aug. 2019.

The present invention relates to intelligent robotics system, particularly to an improved system configured to pick up tennis balls autonomously.

### BACKGROUND OF THE RELATED ART

Tennis is a sport in which player uses racket to hit the ball against the opponent. It is an Olympic sport and is played at all levels of society and at all ages. Nowadays players use machines that service tennis balls across the court. The practising person had to collect the balls scattered across the tennis court. This leads to considerable wastage of practice sessions or time. There are many semi-autonomous and autonomous devices available in market that collect tennis balls scattered in the court during practice sessions. Many of them are semi-autonomous and require the players to push the device around the court in order to collect the balls. Although these devices assist the players in the collection process but are still not independent of human participation.

Chinese Patent Publication No. CN207429620U, describes a utility model relating to a tennis robot including information acquisition device, controller, moving carrier device and tennis collection device, information acquisition device and controller all set up in on the moving carrier device.

Chinese Patent Publication No. CN107962564A, describes a robot system includes a primary robot frame including a computerized control module providing control commands for the robot system, and the primary robot frame includes an outer perimeter. The robot system further includes a plurality of submodules, each submodule is capable of being selectively docked with the primary robot frame, and each of the submodules provides different functionality to the robot system.

Martin et al., Spanish Patent Publication No. ES1073031U describes an automatic ball picker, which is intended for use in the tennis courts in order to automatically collect the balls distributed capriciously during training and practice of said sports, characterized in that it comprises a robot by means of which the direct collection of the balls is carried out, and a column with a ball storage basket, under whose column and basket the robot is apt to be located for the unloading of the balls of the latter on the basket; with the particularity that said robot includes an entrance of balls with two rollers, propellers for the transfer of the balls and a storage tank for the balls themselves, said robot being autonomous in its movement and collection of the balls.

Chinese Patent Publication No. CN108854017A, describes an invention disclosing a tennis ball picking and serving integrated robot. The robot comprises a mobile vehicle body, a collecting and serving device, a manipulator assembly and a control system. The robot can effectively solve the problem about autonomous positioning, ball serving and ball picking in a tennis training field, the automatic ball picking function of the tennis training field is achieved, balls with different speeds and position states can be served.

Chinese Patent Publication No. CN204395362U describes a utility model disclosing a tennis ball automatic collector. The tennis ball automatic collector comprises collector main bodies and special tennis balls, wherein the collector main bodies are arranged on a tennis court, an electromagnet is arranged in each collector main body, a power line electrically connected with each electromagnet is arranged on each collector main body. The tennis ball automatic collector can effectively recycle the tennis balls, is high in recovery efficiency, saves time, and simultaneously can reduce a workload of a worker on the tennis court.

Chinese Patent Publication No. CN104801023B describes an invention disclosing a tennis ball picking system and method of a tennis ball picking machine. The tennis ball picking system comprises a central processing unit, a vision system, a driving system and a tennis ball picking device, wherein the central processing unit is used for receiving measured data of infrared distance measurement sensors and sending out a movement instruction to the driving system according to relevant data.

Eletrabi et al., United States Patent Application No. U.S. Pat. No. 10,011,208B2 describes a dual functional robot for collecting rollable objects capable of a stable upright position and a stable horizontal position,

The above described inventions are merely efficient as they tend to detect and collect balls predominantly in linear direction as a result missing tennis balls that were lying elsewhere. Also, in the process the conventional prior arts waste electric energy as they neither perform a 360-degree scan to identify the closest ball and follow the shortest available path. Moreover, most prior arts have a ramp positioned to receive tennis ball from the rotating collector and thus guiding the ball to the holding basket via a projectile path. There are chances that ball may bounce out of the ball collection basket during a process. The present invention is designed to overcome the above disclosed shortcomings and provide an efficient system of collecting scattered tennis balls during the playing sessions.

### SUMMARY OF THE INVENTION

The disclosed system is a compact autonomous robot meant to collect balls during tennis match or tennis practicing activities. This invention is meant to automate the task of collecting scattered tennis balls in the court. This invention uses an amalgamation of mechanical design and technology. The present robotic system automatically moves towards a ball until it is close enough to be collected.

It is an object of the present invention to save time and reduce wastage of electricity. This object is achieved as the system scans the tennis court in all directions to identify scattered balls and then intelligently calculate a shortest path for collecting the balls. This process is repeated until all the scattered balls are picked up.

It is also an object of the present invention to prevent clogging of balls during its collection. The robotic system achieves this by the timely execution of an algorithm.

It is another object of present invention, to offer a compact assembly with enhanced ball collection capacity. The present invention achieves this with a combination of an engineered paddle and screw system, which captures the ball, and then elevates it up using a motor-driven screw.

It is yet another objective of the present invention to collect with ease, the balls resting along the back fence of the court, without causing the robot to become stuck on the fence. The present invention achieves this with the combination of sensors, an algorithm, an engineered arm and a motor driven rotating brush.

It is further object of the present invention to elevate the ball to a desired height, and then eject it safely into the ball collection basket. It does this with a combination of multi-level/multi-tier curved capture basin, screw, screw arm, lifting tab, and column/cylinder ridge assembly.

It is also an object of present invention to use computer vision technology and a custom trained neural network machine learning model to detect the balls laying scattered in the court.

### BRIEF DESCRIPTION OF THE ACCOMPANYING DRAWINGS

FIG. 1 illustrates various modules of the autonomous tennis ball picking robot.

FIG. 2A illustrates exemplary diagram of front perspective view of the autonomous tennis ball picking robot.

FIG. 2B illustrates exemplary diagram of side perspective view of the autonomous tennis ball picking robot.

FIG. 3 illustrates exemplary diagram of the engineered screw and foot system of the autonomous tennis ball picking robot.

FIG. 4 illustrates exemplary diagram of the multi-tiered surface capture basin of the autonomous tennis ball picking robot.

FIG. 5 illustrates exemplary diagram of the screw with its graduated curved appendage screw arm in the autonomous ball picking robot.

Other aspects of the present invention shall be more readily understood when considered in conjunction with the accompanying drawings, and the following detailed description, neither of which should be considered limiting. Each of the objects stated above will be described in further detail in the next sections.

### DETAILED DESCRIPTION OF THE PREFERRED EMBODIMENTS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

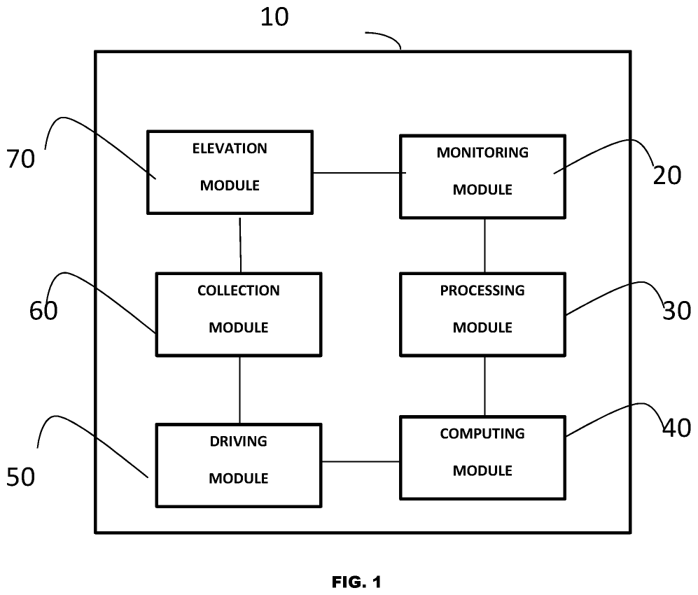

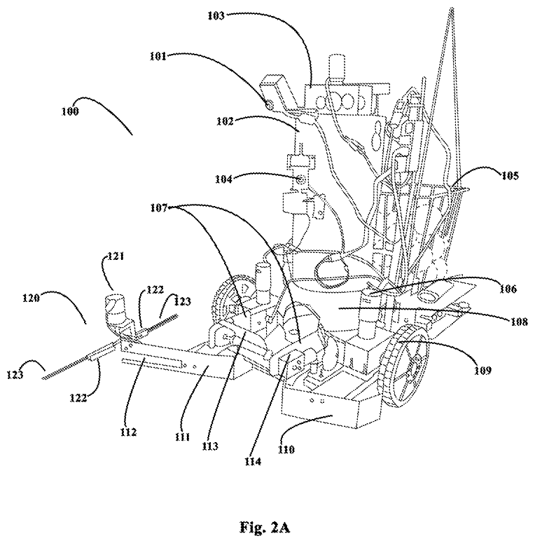

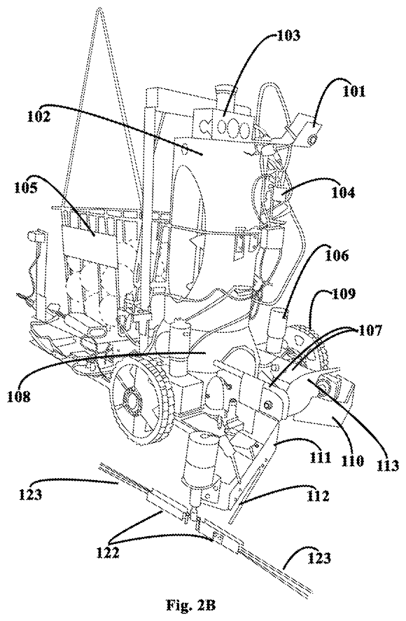

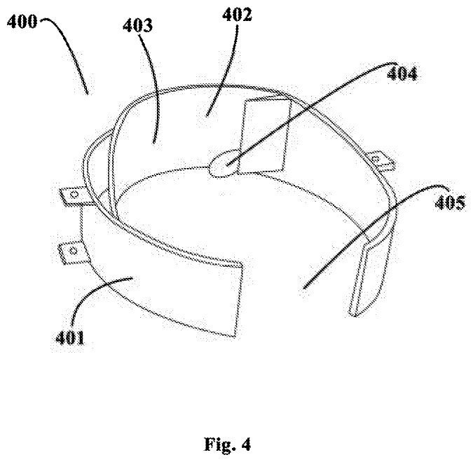

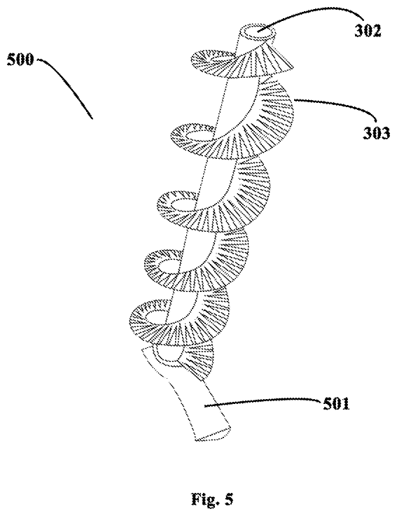

FIG. 1 is a block diagram of an automatic tennis ball collecting robotic system 10. The system 10 comprises of a monitoring module 20, a processing module 30, a computing module 40, a driving module 50, and a collection module 60 and elevation module 70. The monitoring module 20 includes at least one camera 101 (refer FIG. 2A), and plurality of sensors (104 and 106 by way of an example). The processing module 30 is configured to analyse and process the data accumulated by the monitoring module 20. The driving module 50 further comprises, a base frame with at least two wheels 109 (refer FIGS. 2A and 2B) each capable of being actuated by an independent motor. The collection module 60 further comprises at least two forward extending arms 110 and 111 (refer FIGS. 2A and 2B) guiding the balls lying in the near vicinity and deflecting the balls lying in front of the wheel 109; the collection module further comprises a multi-tiered capture basin 400 (refer FIG. 4) and a hinged paddle 113 (refer FIGS. 2A and 2B) configured to rotatably capture the ball. The elevation module 70 comprises a rotatable screw 500 (refer FIG. 5) coupled to a screw motor.

FIG. 2A and FIG. 2B illustrates a tennis ball picking robot 100. The tennis ball picking robot 100 in its active state continuously scans whether balls are lying strewn across the court. A front facing camera 101 is mounted on the top of the cylinder 102 to capture live video frames during the operation. The tennis ball picking robot 100 has a computing module further comprising general components like processor, random access memory and read only memory. Apart from the general components, the integrated circuit board of processing module also have wired or wireless communication channels to communicate with the camera sensor 104 and distance sensors 106. The read only memory stores the computer vision algorithm and custom trained neural network for detecting the ball and picking it up.

When the robotic system 100 is switched on, the custom trained neural network algorithm is executed by the computing module of the robotic system 100 and the robotic system 100 scans the surrounding area to detect the scattered balls lying in the court. The robotic system 100 uses the position of scattered ball in the frame to determine in which direction to steer the robot 100. If there is more than one ball present in the court, the robotic system 100 identifies which ball is closest. The robotic system 100 then propels the wheels 109, and steers itself closer to the scattered ball in order to enable the hinged paddle 113 to capture the ball, further taking it up onto a ramp into the capture basin 400 (refer FIG. 4).

As the robotic system 100 propels towards the closest ball, the controlling module executes an algorithm which precisely aligns the robotic system 100 with respect to the closest ball. The alignment of the robotic system 100 would be such that the ball lies towards the centre of the paddle 113, with a certain degree of tolerance.

In the case that the balls are lying scattered in large clusters, the robotic system 100 from an initial position, using the camera sensors 104 identifies the cluster in the nearest proximity, and if the number is greater than a predetermined value, the robotic system propels towards the cluster and breaks it up into small clusters. The robotic system 100 then propels back to its initial position and reassess the closest cluster.

As the robotic system 100 moves forward, it further guides other balls lying in close proximity to the nearest ball towards the paddle 113 using one of the engineered arms 111. Also, the robotic system 100 using a rotatable brush 123 coupled to the arm 111 rotatably pushes the balls lying alongside the boundaries (such as a wall or a fence) towards the paddle 113.

The paddle 113 is attached to the hinged support beams 107 on either side of the ramp. The hinged support beams 107 are loaded with springs to enhance flexibility of the said apparatus. This allows free vertical movement of the paddle 113 to assist in the ball capture process and minimize the chances of clogging. The walls of the cylinder 102 provides structural support for the screw system 500 (as described in FIG. 5) and motor housing 103.

A paddle motor 114 is installed on either of the hinged support beam 107 to rotate the paddle 113. The paddle 113 has a curved shape to cradle the tennis ball as it is pushed up the ramp. There are two forward arms 110 and 111 placed opposite to each other on sides of the paddle 113 in order to guide balls towards the paddle 113.

An algorithm executed by the controlling module prevents potential clogging of balls near the paddle 113 and within the cylinder 102. In the case that the paddle 113 becomes clogged and stops moving during the collection process, the controlling module executes an algorithm which immediately reverses the rotation of the paddle motor 114 and further unclogs the robotic system 100. Once the robotic system 100 has been unclogged, the controlling module further executes previous algorithm to reverse the rotation and continue the collection process.

Among the two forward arms 110 and 111, One arm 110 is shorter than the other arm 111. The shorter arm 110 having one or more bends deflects the balls lying in front of the tyre towards the side of the robotic system 100. The longer arm 111 with one bent has a brush motor assembly 120 installed to its one end.

The brush motor 121 is installed in such a way that the plane of rotation lies parallel to the ground. A blade 122 is coupled to the brush motor 121 on its shaft. The blade has a metallic portion 122 which from its one end is connected to a brush like portion 123. The metallic portion 122 is composed of short, segmented blades 122 arranged opposite to each other on the shaft. The brush like portion 123 is composed of multiple, flexible longitudinally extending bristles.

The brush motor assembly 120 is secured on the arm 111 in such a way that the blade 122 stays few centimetres above the ground without touching it. The long arm 111 has a slit 112 to enable the rotation of the blades 122 through the arm 111.

The robotic system 100 using the brush motor assembly 120, rotatably pushes the balls that are lying within the swept area of the blade towards the paddle 113 to enable easier collection.

The robotic system 100 uses a combination of its distance sensors 106, camera 101, and machine learning model to identify balls that are at the same distance as an object ahead. As the robotic system 100 approaches the object, it scans the sides of the object in order to identify the object as a wall or fence. The robotic system 100 then orients itself to be perpendicular with the fence. It further uses a combination of a digital compass, distance sensors 106, and an algorithm to turn parallel with the fence in such a way that the rotating brush 123 is aligned with the edge of the fence. The robotic system 100 then propels forward along the fence where after it rotatably pushes the balls away from the fence using the brush 123.

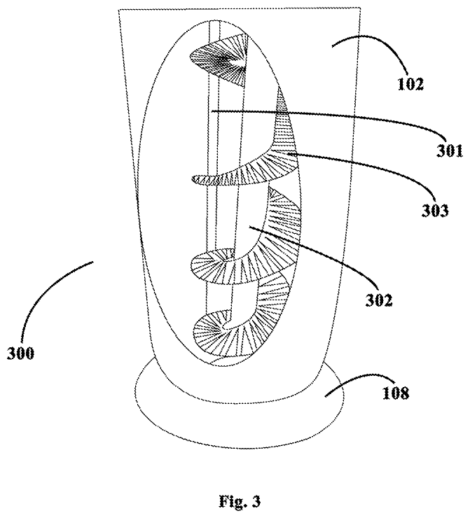

The cylinder assembly 300 as shown in FIG. 3 consists of the cylinder base 108, cylinder 102, cylinder ridge 301, screw column 302 and screw helices 303 respectively. The capture basin 400 (refer FIG. 4) receives the ball from the ramp. Once the ball enters the capture basin 400, a hemispherical depression in the front side of the basin floor holds the ball until the screw arm 501 (refer FIG. 5) of the rotating screw comes around and moves the ball towards the rear side 403 of the multi-level capture basin 400. The ball then engages with the cylinder ridge 301. The cylinder ridge 301 is a thin rigid beam that runs entirely through the length of the cylinder 102. It provides resistance to help force the ball upwards along a straight vertical line during operation. The walls of the cylinder 102 provides structural support for the screw assembly and motor housing 103 (as described in FIGS. 2A & 2B).

FIG. 4 illustrates the exemplary view of the capture basin 400 which is arranged within the cylinder base 108. More specifically, the capture basin 400 comprise of two curved walls—an outer circular wall 401 and inner elliptical wall 402. The outer circular wall 401 provides the primary structure and support for the cylinder 102 (as disclosed in FIG. 3). The inner elliptical wall 402 gradually guides the ball from the circumference of the outer base wall 402, to the circumference of the main cylinder 102 as the ball is being pushed by the screw arm 501 (as shown in FIG. 5) which is a curved appendage at the bottom of the screw assembly 500. The inner wall 402 is slightly elevated off the platform in order to allow the screw arm 501 to freely pass under it during rotation, while still guiding the ball inwards.

The screw assembly 500 as shown in FIG. 5 rotates and picks the ball from the front side 405 of the capture basin 400, and moves it to the rear side 403 of the capture basin 400. The cylinder base 108 (as described in FIG. 3) is wider at the bottom (so as to house the capture basin 400) and gradually narrows towards the top where it connects with the cylinder 102. As the ball is moved towards the rear side 403, the second tier surface of the capture basin forces the ball towards the centre of screw column 302 (refer FIG. 3) until the ball is close enough to engage with the screw helices 303.

A small elevated ramp 404 (refer FIG. 4) at the rear side 403 of the capture basin 400 assists in lifting the ball up through the motor driven screw or screw assembly 500 (as described in FIG. 5). The screw arm 501 moves freely just beneath the elevated ramp surface, and back around to capture the next ball. As the ball engages with the screw helices 303, it also engages with the cylinder ridge 301 (as disclosed in FIG. 3) within the capture basin and is forced to start moving upwards in a straight line along the ridge 301, into the cylinder 102, and towards the ejection port at the top of the cylinder 102. Once the ball reaches the port, the motion of the screw assembly 500 gently pushes the ball out, where it falls into the ball collection basket 105 (as shown in FIG. 2A).

After collecting each ball, the tennis ball collecting robot 100 searches for another ball which is closest to the robotic system 100 and repeats the same process again to pick up the ball and store it in the ball collection basket 105 (refer FIG. 2A). This helps the robotic system 100 to avoid doing multiple rounds of the court for ball collection, thereby improving energy efficiency of the robotic system 100.

As used herein, the term “tennis ball collection robot” means a robot which automatically collects tennis balls during and after practice sessions of the tennis player. The term “engineered arm” or “arm” are used interchangeably. Also, the term “engineered paddle” or “paddle” or “hinged paddle” are used interchangeably. Further, “elevated ramp” or “lifting tab” are used interchangeably. The term “motor-driven screw” means a screw driven by a motor. The term “cylinder” or “column” means a solid geometrical figure with straight parallel sides and a circular or oval cross section. The term “ridge” means top or crest of the system. The term “ramp” means a sloping surface joining two different levels. The term “hinge support beams” means a support which can resist both vertical and horizontal forces. The term “two forward arms” means two arms extending in the forward direction. The term “paddle” means a short pole with a broad plate at one or both ends. The term “blade” means both the blade and the brush which is attached at the tip of the rotating shaft. The term “collection basket” means a container used to hold or carry things. The term “capture basin” means base of the cylinder when taken apart. The term “screw” means a short, slender, sharp-pointed metal pin with a raised helical thread running round it and a slotted head, used to join things together by being rotated and is held tightly in place. The “screw arm” means the graduated curved appendage located at the base of the screw system. The term “cylinder wall” means the walls of the cylinder. The term “ball ejection port” means an opening in the receiver through which the balls are thrown from the piece. The term “cylinder ridge” means the long narrow top of the cylinder. The term “camera” means a device for recording visual images in the form of photographs, film, or video signals. The term “outer wall” means circular and provides the primary structure and support for the cylinder. The “inner wall” means elliptical and is used to gradually guide the ball from the circumference of the outer base wall, to the circumference of the main cylinder as the ball is being pushed by the screw arm and the term “screw column” means the column where the screw is fixed.

What is claimed is:

1. An intelligent autonomous robotic apparatus for the collection of tennis balls comprising:
a monitoring module;
a processing module;
a computing module;
a driving module;
a collection module;
an elevation module.
a collection basket;
a cylindrical housing comprising cylindrical ridge;
multi-tiered capture basin with hemispherical depressions;
hinged paddles;
extended arms with bends;
rotating brush;
motors comprising brush motor, paddle motor and screw motor;
rotatable screw with helices and screw arm;
ultrasonic sensors including but not limited to camera or vision sensors and distance or proximity sensors;
wheels, cameras and base frame.

2. An autonomous robotic apparatus for the collection of tennis balls according to claim 1, wherein the monitoring module further comprises:
a plurality of cameras to capture the images of the scattered balls; and
a plurality of ultrasonic sensors to determine the position and the obstacles within the path;

3. An autonomous robotic apparatus for the collection of tennis balls according to claim 2, wherein the monitoring module analyses and processes the data related to nearest ball, the shortest path towards the nearest ball, and nearest obstacle.

4. An autonomous robotic apparatus for the collection of tennis balls according to claim 1, wherein the driving module further comprises a base frame with at least two wheels each capable of being actuated by independent motors.

5. An autonomous robotic apparatus for the collection of tennis balls according to claim 1, wherein the collection module further comprises:
one shorter and one longer extended arms with one or more bends configured to guide the balls lying in the near vicinity and to deflect the balls lying in front of the wheel;
a rotating brush with brush motor installed at its end;
a blade coupled to the brush motor on its shaft;
a hinged paddle configured to rotatably capture the ball; and
a multi-tiered capture basin.

6. The robotic system of claim 5 wherein the collection module is further configured to capture the nearest ball using the rotatable paddle; the paddle further pushes the ball towards the front end of the capture basin.

7. The robotic system of claim 6, wherein the capture basin comprises plurality of hemispherical depressions on the base so as to restrict the free movement of the ball falling in the capture basin.

8. An autonomous robotic apparatus for the collection of tennis balls according to claim 1, wherein the elevation module comprises a screw rotatably coupled to a motor.

9. An autonomous robotic apparatus for the collection of tennis balls according to claim 1, wherein the cylindrical housing further comprises a cylindrical ridge extending internally.

10. The robotic apparatus of claim 8, wherein the rotatable screw further comprises a screw arm on its lower end.

11. The robotic apparatus of claim 10, wherein the rotatable screw arm moves the collected ball from the front end of the capture basin towards the rear end of the capture basin.

12. The robotic apparatus of claim 11, wherein the rotatable screw further comprises graduated screw helices configured to lift the ball form the rear end of the capture basin to a predefined height along the cylinder ridge.

13. The robotic system of claim 1 wherein the ball collection basket is mechanically coupled to the base frame and is externally coupled to the cylindrical housing.

14. The robotic system of claim 1 wherein the top portion of the cylindrical housing further comprises an opening at its rear side to enable the ball to be collected in the ball collection basket.

15. An autonomous robotic apparatus for the collection of tennis balls according to claim 1, wherein:
a plurality of cameras are configured to continuously capture and record the images of scattered balls lying in the court;
the cameras are in electronic communication with the ultrasonic sensors which enable the intelligent identification of the object.

16. An autonomous robotic apparatus for the collection of tennis balls according to claim 3, wherein the processing module is configured to analyse and process the data accumulated by the monitoring module.

17. The robotic apparatus of claim 1, wherein the computing module executes an algorithm which precisely aligns the robotic apparatus with respect to the closest ball.

18. The robotic apparatus of claim 17, wherein the computing module further comprise:
general components like processor, random access memory and read only memory;
wired or wireless communication channels to communicate with the ultrasonic sensors.

19. An intelligent autonomous robotic apparatus for the collection of tennis balls comprising:
a monitoring module;
a processing module;
a computing module;
a driving module;
a collection module;
an elevation module.
a collection basket;
a cylindrical housing comprising cylindrical ridge;
multi-tiered capture basin with hemispherical depressions;
hinged paddles;
extended arms with bends;
rotating brush;
motors comprising brush motor, paddle motor and screw motor;
rotatable screw with helices and screw arm;
ultrasonic sensors including but not limited to camera or vision sensors and distance or proximity sensors;
wheels, cameras and base frame.

20. An intelligent autonomous robotic system for the collection of tennis balls according to claim 19 wherein:
the monitoring module further comprises plurality of cameras to obtain the images of the scattered balls;
the monitoring module comprises a plurality of sensors to determine the position and the obstacles within the path;
the processing module is configured to analyse and process the data accumulated by the monitoring module;
the driving module further comprises, a base frame with at least two wheels, each capable of being actuated by an independent motor;
the collection module further comprises at least two forwardly extending arms guiding the balls lying in the near vicinity and deflecting the balls lying in front of the wheel;
the collection module further comprises a multi-tiered capture basin and a hinged paddle configured to rotatably capture the ball;
the elevation module comprises a rotatable screw coupled to a screw motor.
